(19) United States
(12) Patent Application Publication
(10) Pub. No.: US 2013/0151046 A1
(43) Pub. Date: Jun. 13, 2013

(54) SYSTEM AND METHOD FOR ECO DRIVING OF ELECTRIC VEHICLE

(71) Applicants: Seunggil Choi, Youngin (KR); Jeong Woo Lee, Suwon (KR); Jung Do Kee, Seoul (KR); Chae Mo Yang, Gunpo (KR)

(72) Inventors: Seunggil Choi, Youngin (KR); Jeong Woo Lee, Suwon (KR); Jung Do Kee, Seoul (KR); Chae Mo Yang, Gunpo (KR)

(73) Assignees: KIA MOTORS CORPORATION, Seoul (KR); HYUNDAI MOTOR COMPANY, Seoul (KR)

(21) Appl. No.: 13/570,621

(22) Filed: Aug. 9, 2012

(30) Foreign Application Priority Data
Dec. 9, 2011 (KR) 10-2011-0132281

(51) Int. Cl. B60L 15/20

(52) U.S. Cl. 701/22; 180/65.275; 903/902

(57) ABSTRACT

An eco driving system for an electric vehicle and a method thereof is disclosed. The eco driving system may include: a route generator that generates at least one candidate route from a current position to a destination; an information collector that collects real time traffic information, weather information, and an air conditioning load of the vehicle; an energy consumption amount calculator that calculates energy consumption amount of each candidate route based on 3D geographical information of the candidate route and the real time traffic information, the weather information, and the air conditioning load of the vehicle; a driver tendency detector that analyzes a driver's driving pattern to determine the driving tendency; a data base portion that stores each program and data for guiding the eco driving; and a control portion that selects an echo driving route from the candidate routes corresponding to the driving tendency.

### CROSS-REFERENCE TO RELATED APPLICATION

This application claims priority to and the benefit of Korean Patent Application No. 10-2011-0132281 filed in the Korean Intellectual Property Office on Dec. 9, 2011, the entire contents of which are incorporated herein by reference.

### BACKGROUND OF THE INVENTION

(a) Field of the Invention

The present invention relates to eco driving of an electric vehicle and a method thereof. More particularly, the present invention relates to an eco driving system for an electric vehicle that uses future road information to guide a minimum energy route of an electric vehicle, and a method thereof.

(b) Description of the Related Art

Generally, a navigation system detects a current position of a vehicle through a GPS (global position system) and finds the shortest route or a suggested route to a destination that is input by a driver.

The navigation system displays the shortest route or a suggested route on a 2D plane road, but it is hard to reflect real road conditions because an environmentally-friendly travel route can only be based on a 2D plane. For example, conditions such as a vehicle speed variation, a vehicle load variation, etc. according to a road slope, a curvature degree, lateral wind, etc. is not reflected. Therefore, the 2D plane route does not reflect real road conditions for properly analyzing energy consumption.

In particular, energy consumption of an electric vehicle is varied according to non-power driving, regenerative braking, driving travel, air conditioning operation, a driving pattern, and wind condition. Therefore eco driving logic for merging future driving road information with electric vehicle information is necessary.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an eco driving system for an electric vehicle having advantages of merging future road information with electric vehicle information to select a route from a current position to a destination that will have a minimum electrical energy demand, and a method thereof.

According to one aspect, an eco driving system for an electric vehicle according to an exemplary embodiment of the present invention may include: a route generator that generates at least one candidate route from a current position to a destination; an information collector that collects real time traffic information, weather information, and an air conditioning load of the vehicle; an energy consumption amount calculator that calculates an energy consumption amount for each candidate route based on 3D geographical information of the candidate route and the real time traffic information, the weather information, and the air conditioning load of the vehicle; a driver tendency detector that analyzes a driver's driving pattern according to operation of the electric vehicle so as to determine the driving tendency; a data base portion that stores each program and data for guiding the eco driving; and a control portion that selects a eco driving route from the candidate routes corresponding to the driving tendency.

According to various embodiments, the route generator may divide the 3D geographical information by a predetermined unit to the destination per candidate route.

According to various embodiments, the energy consumption amount calculator may include: a kinetic calculation module that calculates a kinetic energy consumption amount based on 3D coordinates (X, Y, Z), road curvature information, and slope information which are included in the 3D geographical information, traffic schedule information, and the real time traffic information; a driving resistance calculation module that calculates a vehicle energy consumption amount corresponding to a road surface condition and a wind load based on the road surface, wind direction, and wind speed information of the weather information; and an air conditioning load calculation module that calculates an energy consumption amount according to the air conditioning load amount of the vehicle air conditioning system.

According to various embodiments, the traffic schedule information may include, for example, traffic signal and speed limit information for the candidate route.

According to various embodiments, the driver tendency detector may include at least one of: an accelerator speed calculation module that calculates the frequency and speed at which the driver operates an accelerator pedal; a steering speed calculation module that calculates the frequency and speed at which the driver operates a steering wheel; a brake speed calculation module that calculates the frequency and speed at which the driver operates a brake pedal; and a driving pattern determination module that compares the calculated frequency and speed of the accelerator pedal, the steering wheel, and the brake pedal with base frequency and speed data and determines whether the driving tendency is categorized as aggressive, normal, or defensive.

According to various embodiments, the control portion may predict a travel energy consumption amount and a minimum energy condition for each of the candidate routes, and may generate at least one eco driving route that reduces energy consumption of the electric vehicle in a real road travel condition. The control portion may categorize each of the at least one eco driving route as one of the following types: a dynamic path, a normal path, and a mild path.

According to various embodiments, the control portion may select as the eco driving route the dynamic path if the driving tendency of the driver is aggressive, the normal path if the driving tendency is general, and the mild path as an eco driving route if the driving tendency is mild.

According to various embodiments, the data base portion may store the 3D geographical information and driving information according to the eco driving use history of the driver.

According to various embodiments, an input and output display portion that can perform input and output through a touch screen may display an eco routing menu for the electric vehicle and may receive the destination for generating a route.

According to another aspect, an method for guiding eco driving of an electric vehicle is provided. The method may include a) generating at least one candidate route from a current position to a destination through a route generator, b) collecting real time traffic information, weather information, and a vehicle air conditioning load amount thorough an information collector, c) calculating an energy consumption amount of each candidate route based on 3D geographical information, real time traffic information, weather information, and a vehicle air conditioning load amount of each candidate route through an energy consumption amount calculator, d) analyzing a driving pattern according to the driver's operation of the electric vehicle to detect a driving tendency through a driver tendency detector, and e) selecting an eco driving route from among each candidate route that corresponds with the driving tendency of the driver, and guiding the electric vehicle through the eco driving route through a control portion.

According to various embodiments, the a) step may include selecting the 3D geographical information from a previous driving route through the route generator if the candidate route information is in the stored driving routes, or generating 3D geographical information of the candidate route through an ADAS (advanced driver assistance system) map if the candidate information is not.

According to various embodiments, the c) step may include: calculating a kinetic energy consumption amount in a vehicle based on 3D coordinates (X, Y, Z), curvature information, slope information, and traffic schedule information included in the 3D geographical information and the real time traffic information; calculating a vehicle energy consumption amount according to a road surface condition and a wind load based on the road surface, wind direction, and wind speed information included in the weather information; and calculating an energy consumption amount according to the air conditioning load amount of a vehicle air conditioning system.

According to various embodiments, the d) step may include: calculating frequency and speed at which the driver operates an accelerator pedal; calculating frequency and speed at which the driver operates a steering wheel; calculating frequency and speed at which the driver operates a brake pedal; and comparing the calculated frequency and speed at which the driver operates the accelerator pedal, the steering wheel, and the brake pedal with predetermined base frequency and speed data, and determining whether the driving tendency is aggressive, normal, or defensive.

According to various embodiments, the e) step may include generating at least one eco driving route for reducing energy consumption of the electric vehicle, and includes categorizing each of the at least one eco driving route as one of the following: a dynamic path, a normal path, and a mild path.

According to various embodiments, the e) step may include selecting one of the dynamic route, the normal route, and the mild route as the eco driving route depending on the driving tendency. For example, if the driving tendency is aggressive, then the dynamic route may be selected, if the driving tendency is normal, then the normal route may be selected, and if the driving tendency is defensive, then the mild route may be selected.

In the above configuration, an eco driving route for minimizing energy consumption may be provided such that non-power driving and regenerative braking during travel of an electric vehicle are increased. In particular, this can be accomplished by merging control between 3D geographical information, traffic volume, and wind information of a future road and vehicle energy.

Also, the efficiency of road travel fuel consumption is improved by guiding the vehicle through eco driving route that minimizes energy consumption. As a result, the travel range of the electric vehicle is increased.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein

FIG. 1 is a sc

[symbol]

FIG. 2 is a block diagram showing a consumption amount calculator according to an exemplary embodiment of the present invention.

FIG. 3 is a block diagram showing a driver model analyzing portion according to an exemplary embodiment of the present invention.

FIG. 4 and FIG. 5 show an eco driving guide method for an electric vehicle according to an exemplary embodiment of the present invention.

### DESCRIPTION OF SYMBOLS

100: driving system

110: input and output display portion

120: route generator

130: information collector

140: energy consumption amount calculator

141: kinetic calculation module

142: driving resistance calculation module

143: air conditioning load calculation module

150: driver tendency detector

151: accelerator speed calculation module

152: steering speed calculation module

153: brake speed calculation module

154: driving pattern determination module

160: data base portion

170: control portion

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that, unless explicitly described to the contrary, the word “comprise” and variations such as “comprises” or “comprising” specify the presence of stated features, integers, steps, operations, elements, and/or components, but do not preclude the presence or addition of one or more other features, integers, steps, operations, elements, components, and/or groups thereof. In addition, the terms “-er”, “-or”, and “module” described in the specification mean units for processing at least one function and operation, and can be implemented by hardware components or software components and combinations thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

While reference is made, in particular, to electric vehicle, it is to be understood that the present system and method may also be applicable to hybrid vehicles and plug-in hybrid electric vehicles. In this specification, 3D geographical information is 3D road information having height information added to a 2D plane map, and has a meaning equal to a 3D map and an ADAS (advanced driver assistance system) map.

Hereinafter, an eco driving system for an electric vehicle and a method according to an exemplary embodiment of the present invention will be described with reference to the drawings.

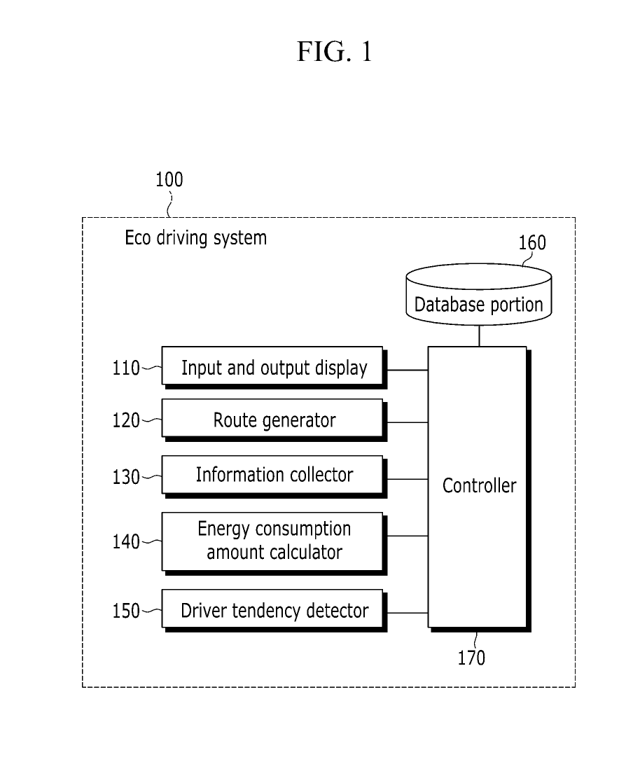

FIG. 1 is a schematic diagram showing an eco driving system for an electric vehicle according to an exemplary embodiment of the present invention.

Referring to FIG. 1, an eco driving system 100 according to an exemplary embodiment of the present invention includes an input and output display portion 110, a route generator 120, an information collector 130, an energy consumption amount calculator 140, a driver tendency detector 150, a database portion 160, and a control portion 170.

The input and output display portion 110 is a display device that can perform input and output functions like a touch screen to receive destination information for generating a route.

The input and output display portion 110 can also display an eco routing menu for an electric vehicle. Thus, the system 100 can merge future road information with electric vehicle information when a user selects the eco routing menu, and can offer a selected minimum energy consumption travel route (also referred to as “eco driving route”). The selected eco driving route may be communicated as a visual type or a sound type.

The route generator 120 analyzes a current position of an electric vehicle through a GPS, and receives a destination from a driver. The route generator 120 then generates one or more candidate routes from the current position to the destination.

In this process, for example, the route generator 120 can generate a plurality of candidate routes through at least one of a minimum distance algorithm, a minimum time algorithm, and a minimum cost algorithm. Here, the minimum cost algorithm can be one that, for example, avoids a toll road included on the candidate route.

Also, the route generator 120 divides the 3D geographical information of a plurality of candidate routes by a predetermined unit (for example, 5 m) to transmit this information to the energy consumption amount calculator 140.

In this process, the divided 3D geographical information is used to calculate a kinetic energy consumption amount, wherein the information is divided so as to analyze a height, a curvature, a slope, and a traffic schedule of the road. The description thereof will be given later.

The information collector 130 may be connected to an outside communication network, like wireless internet (world wide web), to gather real time traffic information and weather information. Here, the weather information can include, for example, road surface condition information such as rain or snow and wind direction/speed information.

Also, the information collector 130 can collect a vehicle air conditioning load amount from a vehicle air conditioning management system (EV HVAC Management System) through vehicle interior communication.

The energy consumption amount calculator 140 calculates an energy consumption amount of each candidate route based on the 3D geographical information for each candidate route transferred from the route generator 120, and the weather information and vehicle air conditioning load amount that are collected from the information collector 130.

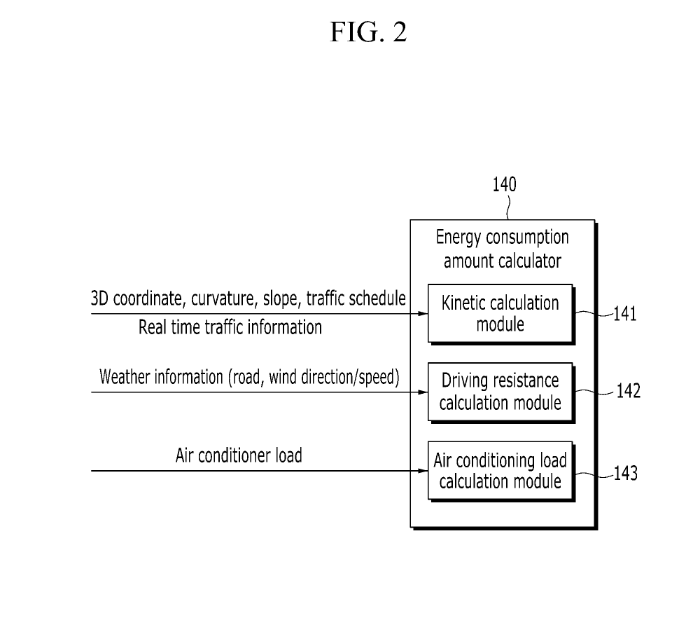

FIG. 2 is a block diagram showing a consumption amount calculator according to an exemplary embodiment of the present invention.

Referring to FIG. 2, the energy consumption amount calculator 140 includes a kinetic calculation module 141, a driving resistance calculation module 142, and an air conditioning load calculation module 143.

The kinetic calculation module 141 calculates a kinetic energy consumption amount of the vehicle based on coordinates (X, Y, Z), curvature information, slope information, traffic schedule information, and real time traffic information that are included in the 3D geographical information. Here, a traffic signal and speed limit information for the candidate route can be included in the traffic schedule information.

The driving resistance calculation module 142 calculates a vehicle energy consumption amount according to a road surface condition and lateral wind load based on the road surface, the wind direction, and the wind speed information that are included in the weather information.

The air conditioning load calculation module 143 calculates an energy consumption amount according to a load amount of a vehicle air conditioning system (not shown).

The driver tendency detector 150 analyzes a driving pattern based on the driver's operation of the vehicle to detect a driving tendency.

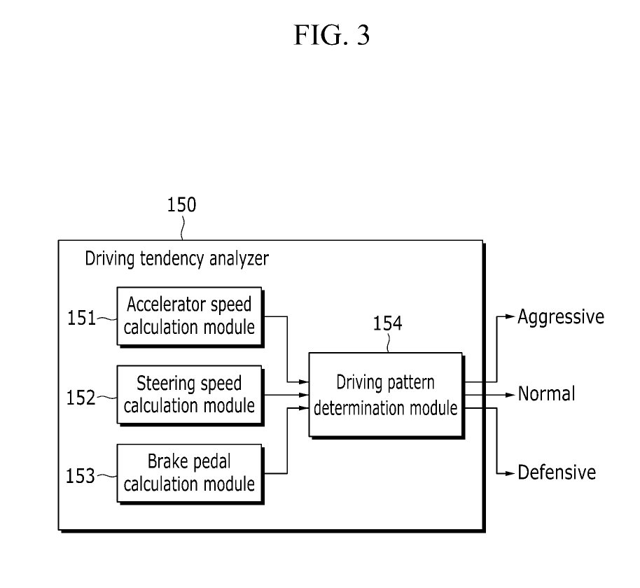

FIG. 3 is a block diagram showing a driver model analyzing portion according to an exemplary embodiment of the present invention.

Referring to FIG. 3, the driver tendency detector 150 according to an exemplary embodiment of the present invention includes an accelerator speed calculation module 151, a steering speed calculation module 152, a brake speed calculation module 153, and a driving pattern determination module 154.

The accelerator speed calculation module 151 calculates frequency and speed at which the driver operates an accelerator pedal.

The steering speed calculation module 152 calculates frequency and speed at which the driver operates a steering wheel (or system).

The brake speed calculation module 153 calculates frequency and speed at which the driver operates a brake pedal.

The driving pattern determination module 154 compares the calculated frequency and the speed of the accelerator pedal, the steering wheel, and the brake pedal with predetermined base frequency and speed data so as to detect the driving tendency of the driver. Further, the driving pattern determination module 154 determines whether the driving tendency is categorized as aggressive, normal, or defensive according to the compared results.

The data base portion 160 stores all of the programs and data for guiding eco driving of the electric vehicle and stores data that is generated during the eco driving.

For example, the data base portion 160 stores 3D geographical information (ADAS map) that is applied to an advanced driver assistance system (ADAS).

The 3D geographical information includes 3D coordinates (X, Y, Z) having height information in combination with prior 2D plane information, curvature information, slope information, and traffic schedule information of a road.

Also, the data base portion 160 can store previous driving information according to eco driving use history of the vehicle.

The control portion 170 can control all portions for operating the eco driving system 100.

According to the exemplary embodiment, the control portion 170 predicts a driving energy consumption amount for each candidate route based on a heat load amount, a kinetic energy consumption amount, and driving resistance. The control portion can then generate an eco driving route having the lowest energy consumption in real road driving conditions based on the predicted energy consumption amount.

The control portion 170 can further merge 3D geographical information, real time traffic information, weather information, and driving resistance information for a road on which the vehicle will drive based on the driving tendency information to offer an eco driving route that matches the driving tendency.

For example, the control portion 170 can divide a plurality of eco driving routes into the following types: a dynamic path, a normal path, and a mild path. For example, a curvature and a slope of the dynamic path is aggressive, a curvature and a slope of the normal path is normal (i.e. is between aggressive and generally planar), and a curvature and a slope of the mild path is generally planar.

The control portion 170 can guide a dynamic, a normal, and a mild eco driving route according to the tendency of the driver that is determined by the driver tendency detector 150.

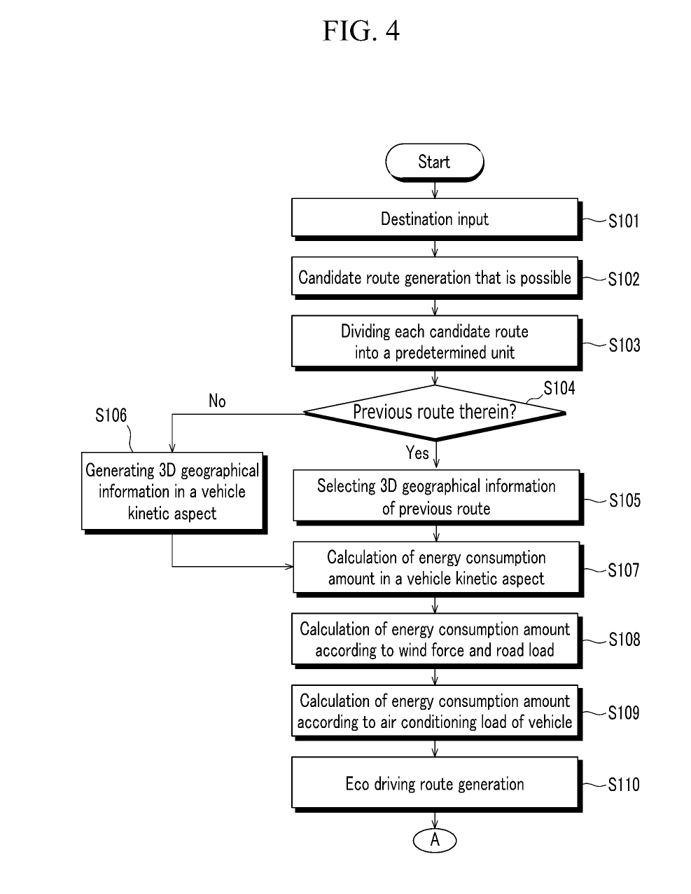

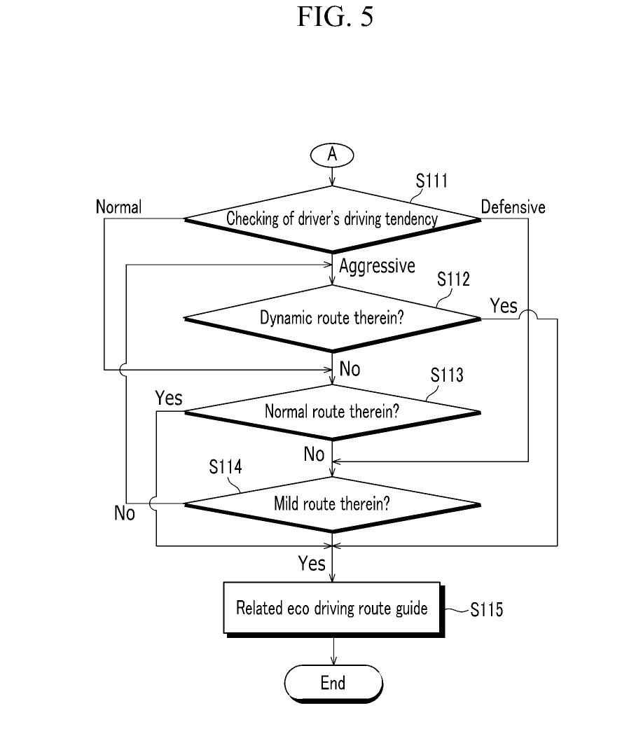

Meanwhile, referring to FIG. 4 and FIG. 5, an eco driving guide method for the eco driving system 100 according to an exemplary embodiment of the present invention is shown, and will be described. Referring to FIG. 4 and FIG. 5, an input and output display portion 110 of the eco driving system 100 according to an exemplary embodiment of the present invention receives destination information from a driver (S101).

The route generator 120 detects a current position of the electric vehicle and generates candidate routes that can reach the destination from the current position (S102).

The route generator 120 also divides the 3D geographical information of each candidate route into predetermined units (for example, 5 m) (S103).

Next, it is determined whether a candidate route is a previous driving route that is stored in the data base portion 160 (S104).

If a candidate route is a previous driving route that is stored in the data base portion 160, (S104; Yes) then the route generator 120 selects 3D geographical information from the previous driving route (S105).

On the other hand, if the candidate route is not a previous driving route that is stored in the data base portion 160 (S104; No), then the route generator 120 generates 3D geographical information of the candidate route through the ADAS (advanced driver assistance system) map (S106).

For example, the previous driving route may be log information on a route that the vehicle has previously driven, for example, a commute route that the driver frequently uses.

The energy consumption amount calculator 140 calculates an energy consumption amount in an aspect of vehicle kinetics based on 3D coordinates (X, Y, Z), curvature information, slope information, traffic schedule information, and real time traffic information that are included in the 3D geographical information (S107).

Also, the energy consumption amount calculator 140 calculates a vehicle energy consumption amount according to the road surface conditions and the wind force based on the wind direction and the wind speed information that are included in the weather information (S108).

Further, the energy consumption amount calculator 140 calculates an energy consumption amount according to a load amount of the vehicle air conditioning system (S109).

The control portion 170 then generates a at least one eco driving route having the lowest energy consumption in real road driving conditions based on a heat load amount, the kinetic energy consumption amount, and driving resistance (S110).

The control portion 170 then confirms a driving tendency of the driver, which is detected by the driver tendency detector 150 (S111).

As a result of step S111, if it is determined that the tendency of the driver is aggressive, then the control portion 170 determines whether a dynamic route is a candidate eco driving route. If a dynamic route is a candidate route (S112; yes), then the portion 170 guides the driver based on the dynamic eco driving route (S115).

However, if the dynamic route is not a candidate route (S112; No), then the portion 170 sequentially checks whether a normal route or a mild route are candidate routes (113, 114 respectively), and the appropriate route can be selected as the eco driving route (S113, S114, and S115). For example, if the tendency of the driver is aggressive, then the preferred route (if a dynamic route is not a candidate route) would be a normal route, followed then by a mild route if a normal route is not a candidate route.

Meanwhile, as a result of step S111, if it is determined that the tendency of the driver is normal, then the control portion checks whether a normal route is a candidate eco driving route. If a normal route is a candidate (S113; yes), then the normal eco driving route is selected and the driver is thus guided (S115).

Meanwhile, if a normal route is not a candidate (S113; No), then the control portion 170 sequentially checks whether a mild route or a dynamic route are candidate routes (114, 112 respectively). If a mild route is a candidate route (114; Yes), then it is selected as the eco driving route and the driver is thus guided (S115). If the mild route is not a candidate route (114; No), then if a dynamic route is a candidate route (112; Yes), then the aggressive route is selected as the eco driving route and the driver is thus guided (S115).

As a result of step S111, if the tendency of the driver is mild, then the control portion 170 checks whether a mild route is a candidate eco driving route (114). If a mild route is a candidate (S114; Yes), then the mild eco driving route is selected and the driver is thus guided (S115).

However, if the mild route is not a candidate (S114; No), then the portion 170 sequentially checks whether a normal route and a dynamic route are candidates (113, 112 respectively), and the appropriate eco driving route is selected and the driver thus guided (with normal being preferred over dynamic in this situation) (S115).

The eco driving system 100 according to an exemplary embodiment of the present invention as described above can be developed alone as an eco routing system for an electric vehicle, or can be developed to work together with a navigation system for a vehicle and a vehicle controller.

Also, the eco driving system 100 can be developed as a navigation system for a vehicle or a separate controller can be used together with the eco driving system 100 to achieve one system in which vehicle information and road information is processed in real time by connecting them with a high speed controller area network (CAN) bus in the vehicle.

As described in an exemplary embodiment of the present invention, an eco driving route for an electric vehicle can be determined and can guide the driver through a route that minimizes energy consumption, wherein 3D geographical information, a traffic flow amount, and driving wind information of the future road are merged with the vehicle energy control such that non-power driving and regenerative braking are increased.

Also, according to an exemplary embodiment of the present invention the eco driving route that is determined and that guides the driver minimizes energy consumption, wherein real road driving fuel consumption efficiency is increased by at least 4% and there is a potential to increase the travel range of the electric vehicle by at least 4%.

Although the above exemplary embodiment is described as using a plurality of units to perform the above process, it is understood that the above processes may also be performed by a single controller or unit.

The above-described embodiments can be realized through a program for realizing functions corresponding to the configuration of the embodiments or a recording medium for recording the program in addition to through the above-described device and/or method, which is easily realized by a person skilled in the art.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An eco driving system for an electric vehicle, comprising:
a route generator that generates at least one candidate route from a current position to a destination of the vehicle;
an information collector that collects real time traffic information, weather information, and an air conditioning load of the vehicle;
an energy consumption amount calculator that an calculates energy consumption amount of each candidate route based on 3D geographical information of each candidate route and the real time traffic information, the weather information, and the air conditioning load of the vehicle;
a driver tendency detector that analyzes a driver's driving pattern according to an operation of the electric vehicle to detect the driving tendency;
a data base portion that stores each program and data for guiding the eco driving; and
a control portion that selects an eco driving route from the at least one candidate route that corresponds to the driving tendency for guiding the electric vehicle.

2. The eco driving system of claim 1, wherein the route generator divides the 3D geographical information by a predetermined unit to the destination per candidate route.

3. The eco driving system of claim 1, wherein the energy consumption amount calculator includes:
a kinetic calculation module that calculates a kinetic energy consumption amount based on 3D coordinates (X, Y, Z), road curvature information, and slope information that are included in the 3D geographical information, traffic schedule information, and the real time traffic information;
a driving resistance calculation module that calculates a vehicle energy consumption amount corresponding to a road surface condition and a wind load based on road surface, wind direction, and wind speed information of the weather information; and
an air conditioning load calculation module that calculates an energy consumption amount according to the air conditioning load amount of the vehicle air conditioning system.

4. The eco driving system of claim 3, wherein the traffic schedule information includes traffic signal and speed limit information on each of the candidate routes.

5. The eco driving system of claim 1, wherein the driver tendency detector includes at least one of:
an accelerator speed calculation module that calculates frequency and speed at which the driver operates an accelerator pedal;
a steering speed calculation module that calculates frequency and speed at which the driver operates a steering wheel;
a brake speed calculation module that calculates frequency and speed at which the driver operates a brake pedal; and
a driving pattern determination module that compares the calculated frequency and speed of the accelerator pedal, the steering wheel, and the brake pedal with base frequency and speed data and determines whether the tendency of the driver is aggressive, normal, or defensive.

6. The eco driving system of claim 1, wherein the control portion predicts a travel energy consumption amount and a minimum energy condition of each the candidate routes to generate at least one eco driving route that reduces energy consumption of the electric vehicle in a real road travel condition, and categorizes the at least one eco driving route as a dynamic path, a normal path, or a mild path.

7. The eco driving system of claim 6, wherein the control portion selects the dynamic path if the driving tendency of the driver is aggressive, selects the normal path if the driving tendency is general, and selects the mild path as an eco driving route if the driving tendency is mild.

8. The eco driving system of claim 1, wherein the data base portion stores the 3D geographical information and driving information according to eco driving use history of the driver.

9. The eco driving system of claim 1, wherein an input and output display portion, configured and arranged to perform input and output through a touch screen, displays an eco routing menu for the electric vehicle and receives the destination for generating a route.

10. A method for guiding an eco driving of an electric vehicle, comprising:
a) generating at least one candidate route from a current position to a destination of an electric vehicle through a route generator;
b) collecting real time traffic information, weather information, and a vehicle air conditioning load amount thorough an information collector;
c) calculating an energy consumption amount of each candidate route based on 3D geographical information, real time traffic information, weather information, and a vehicle air conditioning load amount of each candidate route through an energy consumption amount calculator;
d) analyzing a driving pattern according to the driver's operation of the electric vehicle to detect a driving tendency through a driver tendency detector; and
e) selecting a candidate route matching the driving tendency of the driver among candidate routes and guiding an eco driving route for the electric vehicle through a control portion.

11. The method of claim 10, wherein the a) step includes selecting the 3D geographical information from a previous driving route through the route generator if candidate information is in a stored driving route, or generates 3D geographical information of the candidate route through an ADAS (advanced driver assistance system) map if the candidate information is not in a stored driving route.

12. The method of claim 10, wherein the c) step includes:
calculating a kinetic energy consumption amount based on 3D coordinates (X, Y, Z), curvature information, slope information, and traffic schedule information included in the 3D geographical information and the real time traffic information;
calculating a vehicle energy consumption amount according to a road surface condition and a wind load based on a road surface, a wind direction, and wind speed information included in the weather information; and
calculating an energy consumption amount according to the air conditioning load amount of a vehicle air conditioning system.

13. The method of claim 10, wherein the d) step includes:
calculating frequency and speed at which the driver operates an accelerator pedal;
calculating frequency and speed at which the driver operates a steering wheel;
calculating frequency and speed at which the driver operates a brake pedal; and
comparing the calculated frequency and speed that the driver operates the accelerator pedal, the steering wheel, and the brake pedal with predetermined base frequency and speed data, and determining whether the driving tendency is aggressive, normal, or defensive.

14. The method of claim 10, wherein the e) step includes generating at least one eco driving route for reducing energy consumption of the electric vehicle, and includes categorizing each eco driving route as a dynamic path, a normal path, or a mild path.

15. The method of claim 14, wherein the e) step includes selecting one of the dynamic route, the normal route, and the mild route as the eco driving route corresponding to the driving tendency of aggressive, normal, or defensive.

16. A non-transitory computer readable medium containing program instructions executed by a processor or controller, the computer readable medium comprising:
program instructions that provide a command to generate at least one candidate route;
program instructions that provide a command to collect real time traffic information, weather information, and a vehicle air conditioning load amount;
program instructions that provide a command to calculate an energy consumption amount of the at least one candidate route;
program instructions that provide a command to analyze a driving pattern; and
program instructions that provide a command to select a candidate route.
